(19) United States
(12) Patent Application Publication
(10) Pub. No.: US 2003/0123926 A1
(43) Pub. Date: Jul. 3, 2003

(54) Retractable rod-like device of non-circular cross-section

(76) Inventor: Thomas Lin, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/108,551

(22) Filed: Mar. 29, 2002

(30) Foreign Application Priority Data
Dec. 31, 2001 (TW) 90223724

(51) Int. Cl. F16B 7/10

(52) U.S. Cl. 403/109.5

(57) ABSTRACT

A retractable rod-like device is constructed to include an non-circular outer tube having two side holes, a sliding barrel mounted on the outer tube, the sliding barrel having two inside press portions, a spring mounted on the outer tube within the sliding barrel, an inner tube axially slidably inserted into the outer tube and prohibited from rotary motion, and stop members mounted in the side holes of the outer tube and adapted to lock/unlock the inner rod member. The spring supports the sliding barrel in a first position where the stop members lock the inner rod member. When moving the sliding barrel to a second position in direction against the spring force of the spring, the stop members are disengaged from the press portions of the sliding barrel to unlock the inner rod member.

### FIELD OF THE INVENTION

The present invention relates to handles, sticks, and rod-like devices and, more specifically, to a retractable rod-like device of non-circular cross-section.

### BACKGROUND OF THE INVENTION

Length adjustable rod-like devices are commonly seen in our daily life. For example, handles of shears, mops and hoes; frame bars of pogo sticks, kick scooters and folding bicycles. Length adjustable rod-like devices can be adjusted to the best-fit working length (for example, the handles of a shears), or received to minimize space occupation (for example, the frame bar of a pogo stick).

### SUMMARY OF THE INVENTION

It is the object of the present invention to provide a retractable rod-like device of non-circular cross-section, which can easily rapidly adjusted to change its length.

To achieve this object of the present invention, the retractable rod-like device of non-circular cross-section comprises an outer tube, the outer tube having a non-circular cross-section, and at least one side hole through the wall thereof near one end thereof; a sliding barrel fitting the cross-section of the outer tube and mounted on the outer tube and axially moved between a first position and a second position, the sliding barrel comprising at least one press portion respectively disposed at an inner wall thereof corresponding to the at least one side hole of the outer tube, the at least one press portion each having a first end and a second end respectively disposed corresponding to the first position and the second position, the second end being closer to the longitudinal central axis of the sliding barrel than the first end; spring means mounted on the outer tube within the sliding barrel to support the sliding barrel in the first position, the spring means having a first end stopped at the outer tube and a second end stopped at the sliding barrel; an inner rod member inserted into the outer tube, the inner rod member having a non-circular cross-section fitting the outer tube for enabling the inner rod member to be moved axially in and out of the outer tube and prohibited from rotary motion relative to the outer tube; and at least one stop member respectively mounted in the at least one side hole of the outer tube. When moving the sliding barrel to the first position, the second end of each of the at least one press portion of the sliding barrel is pressed on the at least one stop member against the periphery of the inner rod member to lock the inner rod member. When moving the sliding barrel to the second position, the at least one stop member is respectively disengaged from the inner rod member for enabling the inner rod member to be moved axially relative to the outer tube.

### BRIEF DESCRIPTION OF THE DRAWINGS

FIG. 1 is an exploded view of a retractable rod-like device of non-circular cross-section according to a first embodiment of the present invention.

FIG. 2 is a longitudinal view in section of the first embodiment of the present invention showing the sliding barrel moved to the first position.

FIG. 3 is a sectional view taken along line 3-3 of FIG. 2.

FIG. 4 is similar to FIG. 2 but showing the sliding barrel moved to the second position.

FIG. 5 shows an applicable example of the first embodiment of the present invention.

FIG. 6 is an exploded view of a retractable rod-like device of non-circular cross-section according to a second embodiment of the present invention.

FIG. 7 is a longitudinal view in section of the second embodiment of the present invention showing the sliding barrel moved to the first position.

FIG. 8 is a sectional view taken along line 8-8 of FIG. 7.

FIG. 9 is similar to FIG. 7 but showing the sliding barrel moved to the second position.

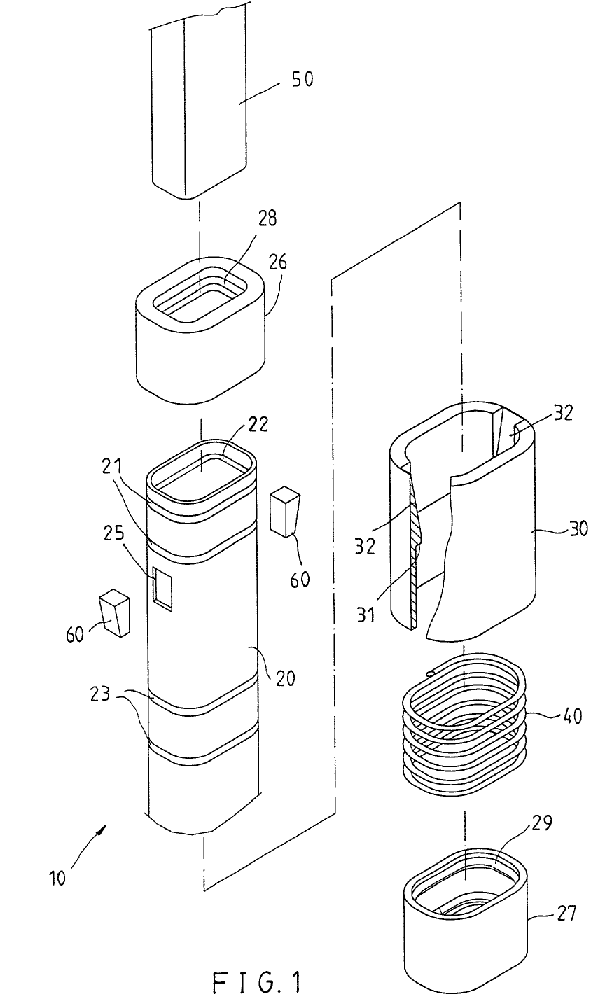

### DETAILED DESCRIPTION OF THE INVENTION

Referring to FIGS. from 1 through 4, a retractable rod-like device of non-circular cross-section 10 in accordance with a first embodiment of the present invention is shown comprised of an outer tube 20, an upper locating ring 26, a lower locating ring 27, a sliding barrel 30, a spring 40, an inner rod member 50, and two stop members 60.

The outer tube 20 (the drawings show only the upper part of the outer tube 20) has an oval (or oblong) cross-section, two upper outside annular grooves 21 extended around the periphery at different elevations near the top end, two upper inside annular flanges 22 respectively protruded from the inside wall near the top corresponding to the upper outside annular grooves 21, two lower outside annular grooves 23 extended around the periphery at different elevations and spaced below the upper outside annular grooves 21, two lower inside annular flanges 24 respectively protruded from the inside wall corresponding to the lower outside annular grooves 23, and two rectangular side holes 25 cut through the peripheral wall at two ends of the major axis between the upper outside annular grooves 21 and the lower outside annular grooves 23. The cross-section and inner diameter of the upper locating ring 26 and the lower locating ring 27 fit the outer tube 20. The upper locating ring 26 is mounted on the outer tube 20 above the side holes 25, having two inside annular flanges 28 respectively engaged into the upper outside annular grooves 21 of the outer tube 20. The lower locating ring 27 is mounted on the outer tube 20 below the side holes 25, having two inside annular flanges 29 respectively engaged into the lower outside annular grooves 23 of the outer tube 20.

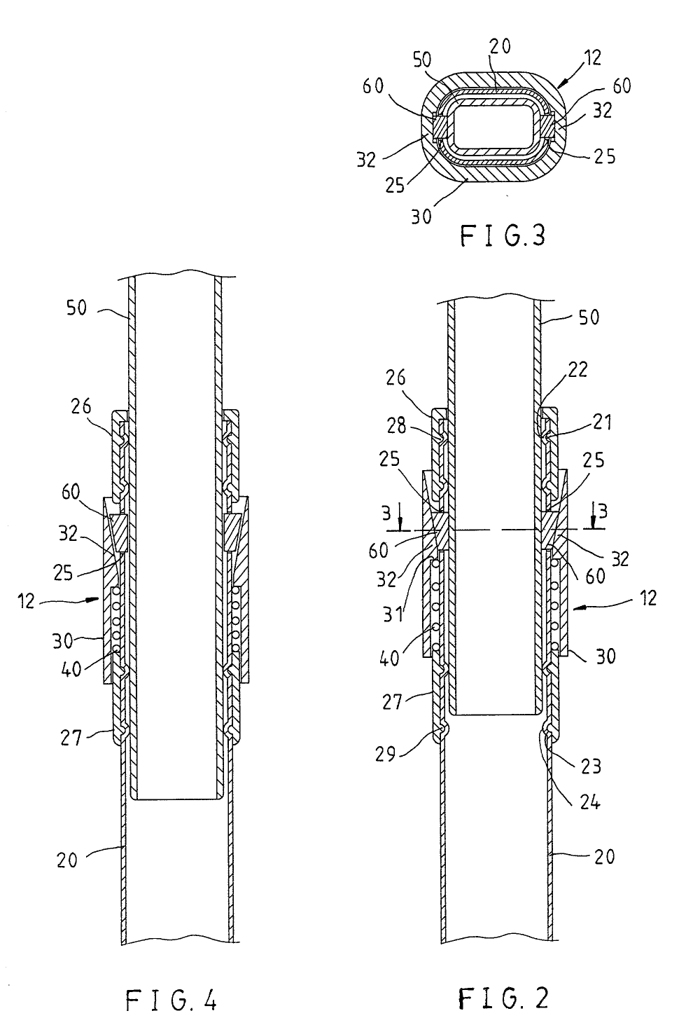

The sliding barrel 30 has an oval (oblong) cross-section similar to the outer tube 20. The outer diameter of the sliding barrel 30 maintains unchanged from the top to the bottom. The upper part of the inner diameter of the sliding barrel 30 is less than the lower part thereof, forming an annular shoulder 31 on the middle of the inside wall of the sliding barrel 30. The sliding barrel 30 further comprises two press portions 32 formed integral with the upper part of the inside wall at two ends of the major axis. The press portions 32 respectively slope downwardly inwards toward the central axis of the sliding barrel in direction from the top end of the sliding barrel 30 to the bottom end thereof, defining a first end and a second end being closer to the longitudinal central axis of the sliding barrel than the first end. The sliding barrel 30 is sleeved onto the outer tube 20 and axially slidably moved between a first position (see FIG. 2) and a second position (see FIG. 4) within the distance between the upper locating ring 26 and the lower locating ring 27, keeping the press portions 32 facing the side holes 25 of the outer tube 20. The sliding barrel 30 is prohibited from rotary motion relative to the outer tube 20 (because of non-circular cross-section).

The spring 40 is an oval coil of a resilient metal wire rod fitting the shape of the outer tube 20 and the sliding barrel 30, and mounted on the outer tube 20 inside the sliding barrel 30 and stopped between the shoulder 31 of the sliding barrel 30 and the top side of the lower locating ring 27 to support the sliding barrel 30 in the first position (see FIG. 2).

The inner rod member 50 (the drawings show only the lower part of the inner tube 50) is a tubular member of oval (oblong) cross-section inserted with its bottom end into the upper locating ring 26 and the outer tube 20, keeping the periphery disposed in contact with the upper inside annular flanges 22 and lower inside annular flanges 24 of the outer tube 20 for smooth movement in axial direction relative to the outer tube 20.

The stop members 60 are beveled (rubber) blocks of high coefficient of friction respectively mounted in the side holes 25 of the outer tube 20 and can be radially slightly moved within a limited distance. The outer and inner sides of the stop members 60 respectively protrude over the outside wall and inside wall of the outer tube 20. The inner sides of the stop members 60 are planar sides disposed in parallel to the outside wall of the inner rod member 50. The outer sides of the stop members 60 are sloping sides disposed in parallel to the sloping press portions 32.

The operation of the retractable rod-like device of non-circular cross-section 10 is outlined hereinafter with reference to FIGS. from 2 through 4 again.

When received no pressure, as shown in FIGS. 2 and 3, the spring 40 supports the sliding barrel 30 in the first position, keeping the protruding bottom end (second end) of the press portions 32 aimed at the side holes 25 of the outer tube 20 to force the stop members 60 to the inner limit position against the outside wall of the inner rod member 50. At this time, the friction resistance between the stop members 60 and the inner rod member 50 prohibits the inner rod member 50 from axial movement relative to the outer tube 20, keeping the inner rod member 50 extended out of the outer tube 20 at a fixed distance, i.e., the inner rod member 50 and the outer tube 20 form the desired length of the retractable rod-like device 10.

When adjusting the length of the retractable rod-like device 10, move the sliding barrel 20 downwards from the first position to the second position against the spring power of the spring 40 (see FIG. 4) with the hand. When moved to the second position, the stop members 60 are released from the radially inwardly compressive force of the press portions 32 of the sliding barrel 30. At this time, the stop members 60 are radially slightly movable, and the inner rod member 50 is disengaged from the stop members 60 for axial movement freely relative to the outer tube 20, and therefore the user can be move the inner rod member 50 relative to the outer tube 20 in axial direction to adjust the length of the retractable rod-like device 10.

When the inner rod member 50 moved axially relative to the outer tube 20 to the desired distance, the sliding barrel 30 is released from the hand, enabling the sliding barrel 30 to be pushed back to the first position by the spring 40. Because the wedge-like press portions 32 slope in one direction, it forces the stop members 60 smoothly inwards during its up stroke. When the sliding barrel 30 reached the first position, the press portions 32 force the stop members 60 against the outside wall of the inner rod member 50 tightly, prohibiting the inner rod member 50 from axial movement relative to the outer tube 20. During adjustment, the user can lock the inner rod member 50 and the outer tube 20 in any position within a limited range to set the retractable rod-like member 10 in the desired length.

In the aforesaid first embodiment of the present invention, the upper locating ring 26 and the lower locating ring 27 limit the moving distance of the sliding barrel 30, decorate the outer tube 20, and support the spring 40. Alternatively, stop flanges may be directly formed at the outer tube 20 to limit the moving distance of the sliding barrel 30 and to support the spring 40 in place instead of the upper locating ring 26 and the lower locating ring 27. Further, the arrangement of the upper inside annular flanges 22 and lower inside annular flanges 24 of the outer tube 20 greatly reduces the friction area between the inner rod member 50 and the outer tube 20 during axial movement of the inner rod member 50 relative to the outer tube 20. A C-shaped clamp (not shown) may be fastened to the bottom end of the inner rod member 50 to stop the inner rod member 50 from escaping out of the outer tube 20 while the C-shaped clamp is engaged with one of the inside annular flanges 24.

In the aforesaid first embodiment of the present invention, two stop members 60 are used to stop the inner rod member 50 at two sides. Alternatively, the retractable rod-like device 10 can be provided with one stop member only.

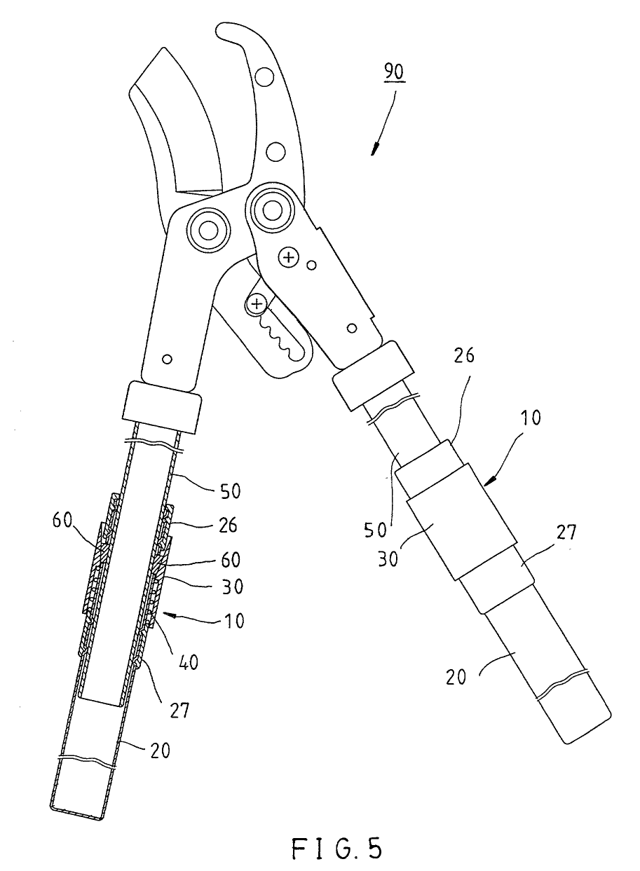

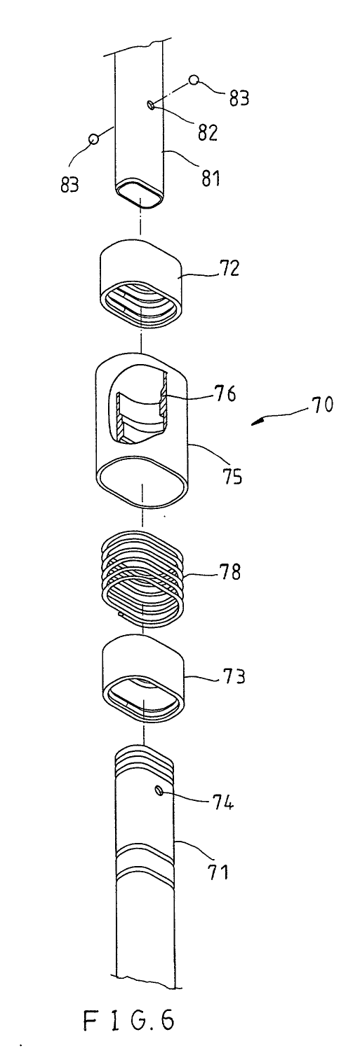

FIG. 5 illustrates an application example of the retractable rod-like device 10. According to this application example, two retractable rod-like devices 10 are used as handles of a shears 90, enabling the user of the shears 90 to adjust the length of the handles conveniently.

FIGS. from 6 through 9 show a retractable rod-like device of non-circular cross-section 70 constructed according to a second embodiment of the present invention. This alternate form is substantially similar to the aforesaid first embodiment (only the different parts will be described in detail). As illustrated, the retractable rod-like device of non-circular cross-section 70 is comprised of an outer tube 71, an upper locating ring 72, a lower locating ring 73, a sliding barrel 75, a spring 78, an inner rod member 81, and two stop members 83.

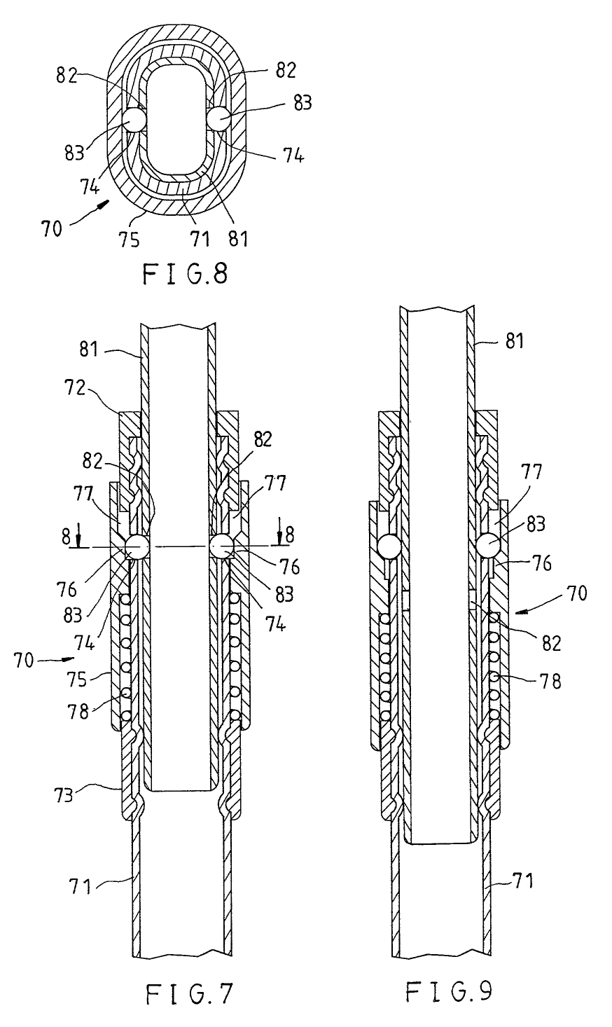

The upper locating ring 72 and the lower locating ring 73 are fixedly fastened to the outside wall of the outer tube 71 at different elevations near the top of the outer tube 71. The outer tube 71 has two circular side holes 74 disposed at two sides between the upper locating ring 72 and the lower locating ring 73. The sliding barrel 75 is mounted on the outer tube 71 and axially moved between a first position (see FIG. 7) and a second position (see FIG. 9), having two press portions 76 respectively inwardly protruded from the inside wall thereof corresponding to the side holes 74 of the outer tube 71, and an inside receiving space 77 above the press portions 76. The press portions 76 each have a sloping upper part sloping downwardly inwards from the top toward the longitudinal central axis of the sliding barrel 75, and a vertically extended planar lower part. The spring 78 is mounted on the outer tube 71 inside the sliding barrel 75 to support the sliding barrel 75 in the first position (see FIG. 7). The inner rod member 81 is a tubular member inserted with its bottom end into the inside of the outer tube 71, having two pairs of circular locating holes 82 respectively disposed at sides near the top end as well as the bottom end (the drawings show only the circular locating holes 82 near the bottom end of the inner rod member 81). The caliber of the circular locating holes 82 is smaller than the side holes 74 of the outer tube 71. The stop members 83 are round balls respectively mounted in the side holes 74, having a diameter smaller than the side holes 74 but greater than the locating holes 82.

Referring to FIGS. 7 and 8 again, when the locating holes 82 of the inner rod member 81 and the side holes 74 of the outer tube 71 aligned in a line, the spring 78 supports the sliding barrel 75 in the first position where the vertically extended planar lower part of each of the press portions 76 is respectively pressed on the stop members 83 to force the stop members 83 into the locating holes 82, keeping the stop members 83 stopped between the inner rod member 81 and the outer tube 71, and therefore the retractable rod-like device 70 is locked.

When adjusting the length of the retractable rod-like device 70, move the sliding barrel 75 downwards from the first position to the second position to lower the press portions 76 of the sliding barrel 75 to the elevation below the side holes 74 of the outer tube 71, keeping the receiving space 77 aimed at the side holes 74. At this time, the user can move the inner rod member 81 to force the stop members 83 out of the inner rod member 81, enabling the inner rod member 81 to be moved axially downwards or upwards relative to the outer tube 71 (see FIG. 9). When the user released the hand from the sliding barrel 75, the stop members 82 are respectively revolvably stopped at the upper part of each of the press portions 76, keeping the sliding barrel 75 in the second position. When the inner rod member 81 moved to such a position that the other pair of locating holes 82 are in line with the side holes 74, the sloping upper part of each of the press portions 76 forces the stop members 83 into the locating holes 82 of the inner rod member 81 to lock the retractable rod-like device 70 again.

According to the aforesaid second embodiment, the inner rod member 81 has two pairs of side holes 82 respectively disposed near the top and bottom ends for enabling the retractable rod-like device 70 to be adjusted between two lengths (the extended position and the received position). Alternatively, the inner rod member 81 can be made having multiple pairs of side holes 81 disposed at different elevations for enabling the retractable rod-like device 70 to be selectively adjusted to different lengths.

What is claimed is:

1. A retractable rod-like device of non-circular cross-section comprising:
an outer tube, said outer tube having a non-circular cross-section, and at least one side hole through the wall thereof near one end thereof;
a sliding barrel fitting the cross-section of said outer tube and mounted on said outer tube and axially moved between a first position and a second position, said sliding barrel comprising at least one press portion respectively disposed at an inner wall thereof corresponding to the at least one side hole of said outer tube, said at least one press portion each having a first end and a second end respectively disposed corresponding to said first position and said second position, said second end being closer to the longitudinal central axis of said sliding barrel than said first end;
spring means mounted on said outer tube within said sliding barrel to support said sliding barrel in said first position, said spring means having a first end stopped at said outer tube and a second end stopped at said sliding barrel;
an inner rod member inserted into said outer tube, said inner rod member having a non-circular cross-section fitting said outer tube for enabling said inner rod member to be moved axially in and out of said outer tube and prohibited from rotary motion relative to said outer tube; and
at least one stop member respectively mounted in the at least one side hole of said outer tube;
wherein when moving said sliding barrel to said first position, the second end of each of said at least one press portion of said sliding barrel is pressed on said at least one stop member against the periphery of said inner rod member to lock said inner rod member; when moving said sliding barrel to said second position, said at least one stop member is respectively disengaged from said inner rod member for enabling said inner rod member to be moved axially relative to said outer tube.

2. The retractable rod-like device of non-circular cross-section as claimed in claim 1, wherein said at least one press portion of said sliding barrel each having an inner surface sloping in direction from the respective first end to the respective second end inwardly toward the longitudinal central axis of said sliding barrel; said at least one stop member is respectively made of material of high coefficient of friction, each having an inner side disposed in parallel to the periphery of said inner rod member and an outer side disposed in parallel to a sloping inner surface of each of said at least one press portion of said sliding barrel.

3. The retractable rod-like device of non-circular cross-section as claimed in claim 1, wherein the at least one press portion of said sliding barrel each has a sloping part sloping inwards in direction from the respective first end toward the respective second end and the longitudinal central axis of the sliding barrel, and a vertically extended planar part disposed at the respective second end corresponding said second position; said inner rod member comprises a plurality of locating holes disposed at different elevations corresponding to the at least one side hole of said outer tube; said at least one stop member each is a round ball adapted to engage the at least one side hole of said outer tube and the locating holes of said inner rod member to stop said inner rod member from axial movement relative to said outer tube when said sliding barrel moved to said first position.

4. The retractable rod-like device of non-circular cross-section as claimed in claim 1, wherein said outer tube comprises two said side holes disposed at two sides.

5. The retractable rod-like device of non-circular cross-section as claimed in claim 1, wherein said outer tube, said sliding barrel, and said inner rod member each have an oval cross-section.

6. The retractable rod-like device of non-circular cross-section as claimed in claim 1, wherein said outer tube has a locating ring fixedly mounted on the periphery thereof; said sliding barrel has a shoulder on the inside thereof, said spring means has the first end and second end thereof respectively stopped at the locating ring at said outer tube and the shoulder of said sliding barrel.
